(19) United States
(12) Patent Application Publication
(10) Pub. No.: US 2013/0095026 A1
(43) Pub. Date: Apr. 18, 2013

(54) CLOSED LOOP PROCESS FOR PREPARING TRICHLOROSILANE FROM METALLURGICAL SILICON

(71) Applicants: Yuecel Oenal, Carl Junction, MO (US); Rainer Malzkorn, Grosskrotzenburg (DE); Ingo Pauli, Schmitten (DE); Ingrid Lunt-Rieg, Bad Homburg (DE); Guido Stochniol, Haltern am See (DE)

(72) Inventors: Yuecel Oenal, Carl Junction, MO (US); Rainer Malzkorn, Grosskrotzenburg (DE); Ingo Pauli, Schmitten (DE); Ingrid Lunt-Rieg, Bad Homburg (DE); Guido Stochniol, Haltern am See (DE)

(73) Assignee: EVONIK DEGUSSA GmbH, Essen (DE)

(21) Appl. No.: 13/522,113

(22) PCT Filed: Dec. 16, 2010
(86) PCT No.: PCT/EP10/69944

§ 371 Date: Dec. 10, 2012

(30) Foreign Application Priority Data
Jan. 18, 2010 (DE) 102010000981.4

(51) Int. Cl. C01B 33/107

(52) U.S. Cl. CPC C01B 33/10763; C01B 33/10757
USPC 423/342; 422/187

(57) ABSTRACT

The present invention relates to a multistage process for preparing trichlorosilane and silicon tetrachloride from metallurgical silicon, in which trichlorosilane and silicon tetrachloride are prepared from metallurgical silicon in a first step, and the silicon tetrachloride is processed further to the trichlorosilane end product in a second step. The present invention further relates to a plant in which such processes can be performed in an integrated manner.

The present invention relates to a process for preparing trichlorosilane and silicon tetrachloride from metallurgical silicon. This is a multistage process in which trichlorosilane and silicon tetrachloride are prepared from metallurgical silicon in a first step, and the silicon tetrachloride is processed further to the trichlorosilane end product in a second step. The present invention further relates to a plant in which such processes can be performed in an integrated manner.

Trichlorosilane can be used, for example, to prepare high-purity silicon. This involves thermal decomposition of trichlorosilane to high-purity silicon. The trichlorosilane in turn can be prepared from metallurgical silicon in a multistage process. Such a procedure is known, for example, from DE 29 190 86.

However, known processes for preparing trichlorosilane generally have the disadvantage that the energy expenditure for the overall process for conversion of metallurgical silicon to trichlorosilane is extremely high. Furthermore, many of the known processes have the disadvantage that they have not been optimized with regard to the formation and the reutilization or further utilization of by-products. Both from an economic and from an ecological standpoint, known processes have a great need for improvement, and in this respect in particular.

It is thus an object of the present invention to provide an optimized technical solution for preparation of trichlorosilane from metallurgical silicon, which meets even the highest demands with regard to the problems mentioned. The object is thus, within a multistage plant, to integrate the product and heat flows such that the reactants and amounts of energy used therein are utilized very efficiently for preparation of the trichlorosilane end product.

This object is achieved by the process components and overall processes, and plant components and overall plants, described hereinafter.

The invention provides, more particularly, a process for preparing trichlorosilane from silicon tetrachloride by hydrodechlorination with hydrogen, wherein at least one silicon tetrachloride-containing reactant stream and at least one hydrogen-containing reactant stream are passed into a hydrodechlorination reactor in which the thermodynamic equilibrium position between reactants and products is shifted in the direction of the products by supply of heat, and wherein a product stream containing silicon tetrachloride, trichlorosilane, hydrogen and HCl is conducted out of the hydrodechlorination reactor, characterized in that the product stream is cooled by means of a heat exchanger and the silicon tetrachloride-containing reactant stream conducted through the same heat exchanger and/or the hydrogen-containing reactant stream is preheated. The product stream may in some cases also contain by-products such as dichlorosilane, monochlorosilane and/or silane.

The equilibrium reaction in the hydrodechlorination reactor is typically performed at 700° C. to 1000° C., preferably 850° C. to 950° C., and at a pressure in the range from 1 to 10 bar, preferably from 3 to 8 bar, more preferably from 4 to 6 bar.

In the process according to the invention, it is preferred that the silicon tetrachloride-containing reactant stream and/or the hydrogen-containing reactant stream is preheated by the product stream coming from the reactor to a temperature level of 150° C. to 900° C., preferably 300° C. to 800° C., more preferably 500° C. to 700° C.

In the process according to the invention, it is envisaged that the cooled product stream can leave the heat exchanger and be conducted into at least one downstream plant component in which silicon tetrachloride and/or trichlorosilane and/or hydrogen and/or HCl can be removed from the product stream.

The at least one plant component just described may also be an arrangement of a plurality of plant components, in each of which one or more of the silicon tetrachloride, trichlorosilane, hydrogen and/or HCl products mentioned can be removed and conducted onwards as a stream. The silicon tetrachloride and hydrogen “products” may in fact also be unconverted reactants. It is also possible here for other by-products present in the product stream, such as dichlorosilane, monochlorosilane and/or silane, to be removed.

In the process according to the invention, it is envisaged that silicon tetrachloride removed can be conducted as a stream into the silicon tetrachloride-containing reactant stream and/or that hydrogen removed can be conducted as a stream into the hydrogen-containing reactant stream, each of which independently can preferably be implemented upstream of the heat exchanger. It is also envisaged that trichlorosilane removed can be withdrawn as an end product stream and/or that HCl removed can be fed as a stream to a hydrochlorination of silicon. It is particularly preferred that all four aforementioned streams removed are conducted and thus utilized correspondingly.

It is envisaged in accordance with the invention that the process is preferably a process for preparing trichlorosilane from metallurgical silicon, characterized in that the at least one silicon tetrachloride-containing reactant stream and the at least one hydrogen-containing reactant stream originate from an upstream hydrochlorination process which comprises the reaction of metallurgical silicon with HCl.

As already mentioned above, at least some of the HCl used in the upstream hydrochlorination process may originate from the HCl stream which has been removed in the plant component downstream of the heat exchanger.

It is envisaged in accordance with the invention that at least a portion of the hydrogen coupling product can be removed in a condenser after the hydrochlorination, and at least silicon tetrachloride and trichlorosilane can be removed from the remaining product mixture in a distillation plant.

It is preferred in the process according to the invention that the hydrogen removed in the condenser and/or the silicon tetrachloride removed in the distillation plant is conducted into the hydrodechlorination reactor, the hydrogen removed more preferably being conducted into the hydrodechlorination reactor via the at least one hydrogen-containing reactant stream and/or the silicon tetrachloride removed via the at least one silicon tetrachloride-containing reactant stream.

The heat for the hydrodechlorination reaction in the hydrodechlorination reactor is typically supplied via a heating chamber in which the hydrodechlorination reactor is arranged. The configuration of the arrangement of heating chamber and hydrodechlorination reactor may be such that one or more reactor tubes are arranged in the heating chamber, the heating chamber preferably being heated by means of electrical resistance heating, or the heating chamber preferably being a combustion chamber which is operated with combustion gas and combustion air.

The process according to the invention can preferably be extended in such a way that the flue gas which flows out of the combustion chamber is used in a downstream recuperator to preheat the combustion air. Optionally, it is additionally possible to use the flue gas flowing out of the recuperator to raise steam.

In a preferred variant of the process according to the invention, which includes any or all of the aforementioned possible variations, the product stream and the silicon tetrachloride-containing reactant stream and/or the hydrogen-containing reactant stream can each be conducted through the heat exchanger under pressure, said heat exchanger comprising heat exchanger elements made of ceramic material. The ceramic material for the heat exchanger elements is preferably selected from Al₂O₃, AlN, Si₃N₄, SiCN and SiC, more preferably selected from Si-infiltrated SiC, isostatically pressed SiC, hot isostatically pressed SiC or SiC sintered under ambient pressure (SSiC).

In all described variants of the process according to the invention, the silicon tetrachloride-containing reactant stream and the hydrogen-containing reactant stream may also be conducted as a combined stream through the heat exchanger.

The pressure differences in the heat exchanger between the different streams should not be more than 10 bar, preferably not more than 5 bar, more preferably not more than 1 bar, especially preferably not more than 0.2 bar, measured at the inlets and outlets of the product gas streams and reactant gas streams.

In addition, the pressure of the product stream at the inlet of the heat exchanger should not be more than 2 bar below the pressure of the product stream at the outlet of the hydrodechlorination reactor, and the pressures of the product stream at the inlet of the heat exchanger and at the outlet of the hydrodechlorination reactor should preferably be the same. The pressure at the outlet of the hydrodechlorination reactor is typically in the range from 1 to 10 bar, preferably in the range from 4 to 6 bar.

In all variants of the process according to the invention, the heat exchanger is preferably a shell and tube heat exchanger.

The invention also provides a plant for reacting silicon tetrachloride with hydrogen to form trichlorosilane, comprising:
a hydrodechlorination reactor arranged in a heating chamber or a combustion chamber, wherein the arrangement may preferably comprise one or more reactor tubes in a combustion chamber;
at least one line for silicon tetrachloride-containing gas and at least one line for hydrogen-containing gas, which lead into the hydrodechlorination reactor or the arrangement of one or more reactor tubes, wherein a combined line for the silicon tetrachloride-containing gas and the hydrogen-containing gas may optionally be provided instead of separate lines;
a line conducted out of the hydrodechlorination reactor for a trichlorosilane-containing and HCl-containing product gas;
a heat exchanger, which is preferably a shell and tube heat exchanger, through which the product gas line and at least the one silicon tetrachloride line and/or the at least one hydrogen line are conducted such that heat transfer from the product gas line into the at least one silicon tetrachloride line and/or the at least one hydrogen line is possible, wherein the heat exchanger may optionally comprise heat exchanger elements made from ceramic material;
optionally a plant component or an arrangement comprising a plurality of plant components for removing in each case one or more products comprising silicon tetrachloride, trichlorosilane, hydrogen and HCl;
optionally a line which can conduct silicon tetrachloride removed into the silicon tetrachloride line, preferably upstream of the heat exchanger;
optionally a line, by means of which trichlorosilane removed may be fed to an end product removal process;
optionally a line which may conduct hydrogen removed into the hydrogen line, preferably upstream of the heat exchanger; and
optionally a line, by means of which HCl removed may be fed to a plant for hydrochlorinating silicon.

The above-described inventive plant can be extended such that the plant is a plant for preparing trichlorosilane from metallurgical silicon, characterized in that the plant additionally comprises:
an upstream hydrochlorination plant with optional conduction of at least a portion of the HCl used via the HCl stream into the hydrochlorination plant;
a condenser for removing at least a portion of the hydrogen coproduct which originates from the reaction in the hydrochlorination plant, this hydrogen being conducted via the hydrogen line into the hydrodechlorination reactor or the arrangement of one or more reactor tubes;
a distillation plant for removing at least silicon tetrachloride and trichlorosilane from the remaining product mixture which originates from the reaction in the hydrochlorination plant, wherein said silicon tetrachloride may be conducted via the silicon tetrachloride line into the hydrodechlorination reactor or the arrangement of one or more reactor tubes; and
optionally a recuperator for preheating the combustion air intended for the combustion chamber with the flue gas flowing out of the combustion chamber; and
optionally a plant for raising steam from the flue gas flowing out of the recuperator.

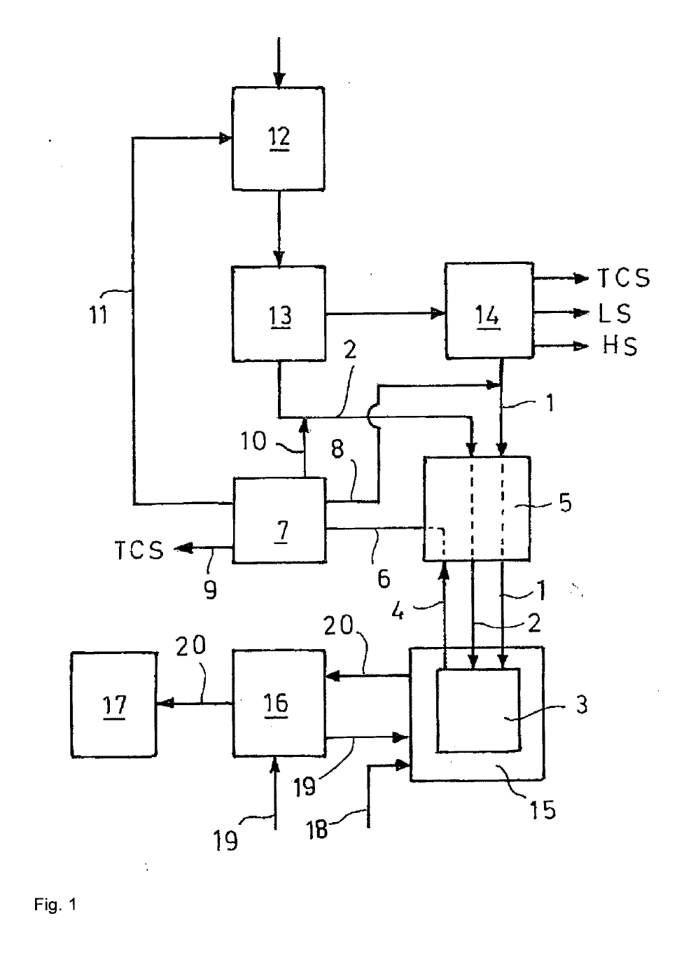

FIG. 1 shows, by way of example and schematically, an inventive plant for preparing trichlorosilane from metallurgical silicon, including a plant component for hydrochlorination of the metallurgical silicon, including important streams.

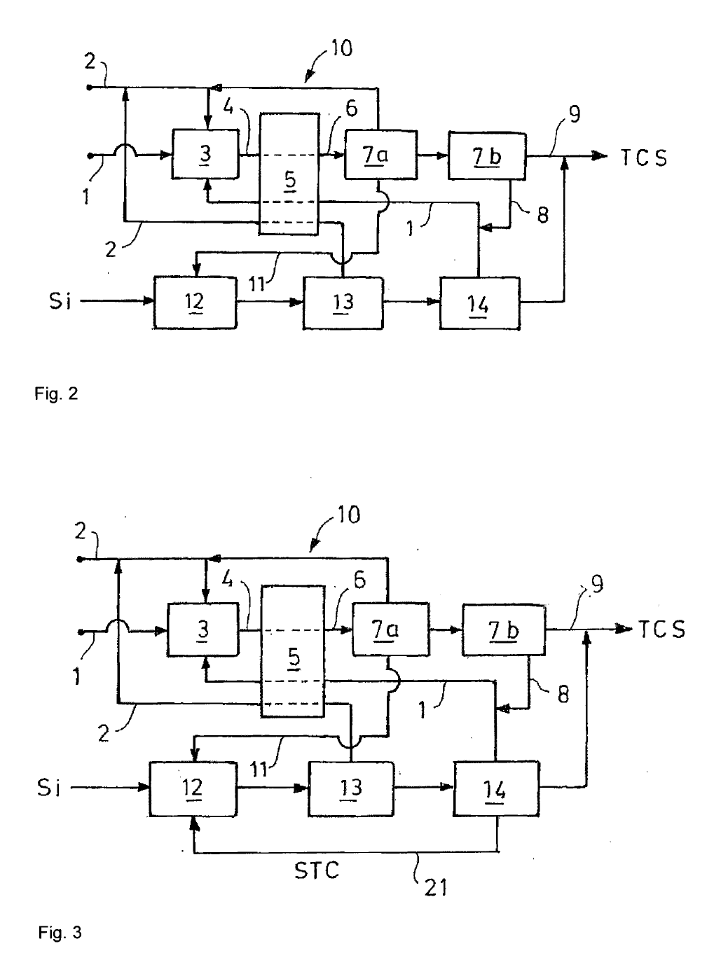

FIG. 2 shows a schematic of an inventive plant variant comprising two distillation lines including important streams, typically particularly suitable in the hydrochlorination of silicon in a fluidized bed reactor.

FIG. 3 shows a schematic of an inventive plant variant comprising two distillation lines including important streams, typically particularly suitable in the hydrochlorination of silicon in a fixed bed reactor.

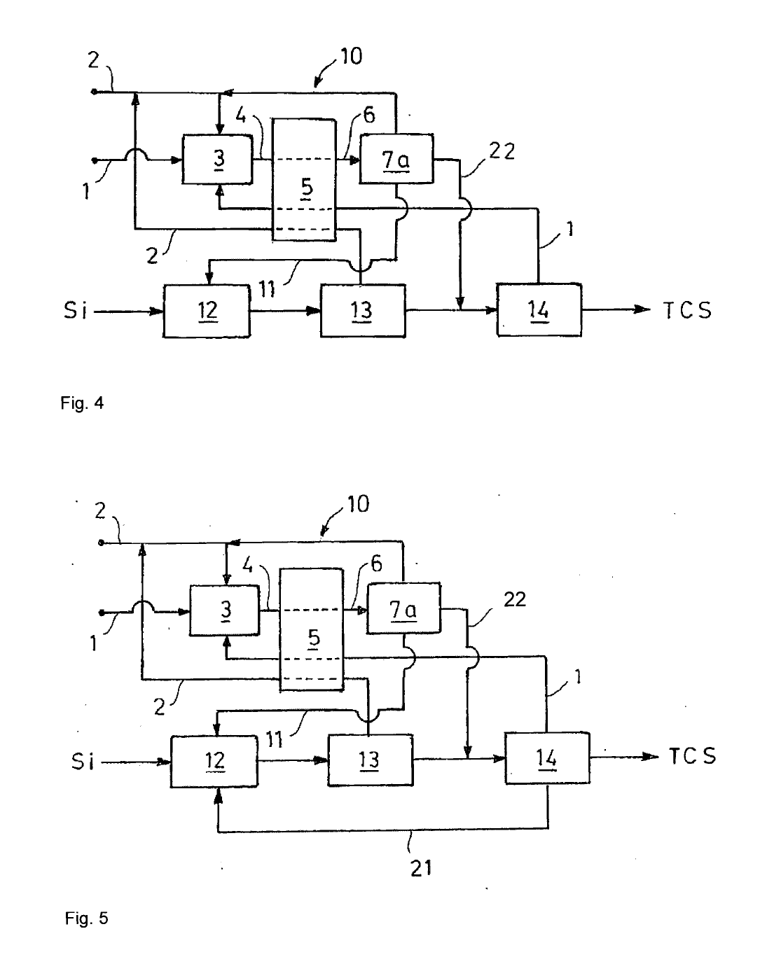

FIG. 4 shows a schematic of an inventive plant variant comprising one distillation line including important streams, typically particularly suitable in the hydrochlorination of silicon in a fluidized bed reactor.

FIG. 5 shows a schematic of an inventive plant variant comprising one distillation line including important streams, typically particularly suitable in the hydrochlorination of silicon in a fixed bed reactor.

The inventive plant shown in FIG. 1 comprises a hydrodechlorination reactor 3 arranged in a combustion chamber 15, a line 1 for silicon tetrachloride-containing gas and a line 2 for hydrogen-containing gas, both of which lead into the hydrodechlorination reactor 3, a line 4 for a trichlorosilane-containing and HCl-containing product gas which is conducted out of the hydrodechlorination reactor 3, and a heat exchanger 5, through which the product gas line 4 and the silicon tetrachloride line 1 and the hydrogen line 2 are conducted, such that heat transfer from the product gas line 4 into the silicon tetrachloride line 1 and into the hydrogen line 2 is possible. The plant further comprises a plant component 7 for removal of silicon tetrachloride 8, of trichlorosilane 9, of hydrogen 10 and of HCl 11. This involves conducting the silicon tetrachloride removed through the line 8 into the silicon tetrachloride line 1, feeding the trichlorosilane removed through the line 9 to an end product removal step, conducting the hydrogen removed through the line 10 into the hydrogen line 2 and feeding the HCl removed through the line 11 to a plant 12 for hydrochlorinating silicon. The plant further comprises a condenser 13 for removing the hydrogen coproduct which originates from the reaction in the hydrochlorination plant 12, this hydrogen being conducted through the hydrogen line 2 via the heat exchanger 5 into the hydrodechlorination reactor 3. Also shown is a distillation plant 14 for removing silicon tetrachloride 1 and trichlorosilane (TCS), and also low boilers (LS) and high boilers (HS), from the product mixture, which comes from the hydrochlorination plant 12 via the condenser 13. The plant finally also comprises a recuperator 16 which preheats the combustion air 19 intended for the combustion chamber 15 with the flue gas 20 flowing out of the combustion chamber 15, and a plant 17 for raising steam with the aid of the flue gas 20 flowing out of the recuperator 16.

### LIST OF REFERENCE NUMERALS

(1) silicon tetrachloride-containing reactant stream
(2) hydrogen-containing reactant stream
(1,2) combined reactant stream
(3) hydrodechlorination reactor
(3a, 3b, 3c) reactor tubes
(4) product stream
(5) heat exchanger
(6) cooled product stream
(7) downstream plant component
(7a, 7b, 7c) arrangement of several plant components
(8) silicon tetrachloride stream removed in (7) or (7a, 7b, 7c)
(9) end product stream removed in (7) or (7a, 7b, 7c)
(10) hydrogen stream removed in (7) or (7a, 7b, 7c)
(11) HCl stream removed in (7) or (7a, 7b, 7c)
(12) upstream hydrochlorination process or plant
(13) condenser
(14) distillation plant
(15) heating chamber or combustion chamber
(16) recuperator
(17) plant for raising steam
(18) combustion gas
(19) combustion air
(20) flue gas
(21) silicon tetrachloride line
(22) trichlorosilane/silicon tetrachloride line

1. A process for preparing trichlorosilane, the process comprising:
passing a first reactant stream comprising silicon tetrachloride, and a second reactant stream comprising hydrogen into a hydrodechlorination reactor,
heating the hydrodechlorination reactor, thereby shifting a thermodynamic equilibrium position in a direction of products, thereby obtaining a product stream comprising silicon tetrachloride, trichlorosilane, hydrogen, and HCl
cooling the product stream with a heat exchanger, and
conducting the first reactant stream, the second reactant stream, or both through the heat exchanger, thereby preheating the first reactant stream, the second reactant stream, or both.

2. The process of claim 1,
wherein the preheating comprises preheating the first reactant stream, the second reactant stream, or both to a temperature of from 150° C. to 900° C.

3. The process of claim 1, further comprising:
conducting the product stream into a downstream plant component after the cooling, and
removing silicon tetrachloride, trichlorosilane, hydrogen, HCl, or a combination thereof from the product stream in the downstream plant component.

4. The process of claim 3,
wherein the downstream plant component comprises a plurality of plant components, and
the removing comprises removing silicon tetrachloride, trichlorosilane, hydrogen, HCl, or any combination thereof in each plant component of the plurality of plant components, and conducting the silicon tetrachloride, trichlorosilane, hydrogen, HCl, or combination thereof onwards as a stream.

5. The process of claim 3, wherein the removing comprises:
removing silicon tetrachloride and conducting it as a stream into the first reactant stream;
removing and withdrawing trichlorosilane as an end product stream;
removing hydrogen and conducting it as a stream into the second reactant stream;
removing HCl and feeding it as a stream to a hydrochlorination of silicon;
or any combination thereof.

6. The process of claim 1, further comprising:
reacting metallurgical silicon with HCl in a hydrochlorination, upstream from the hydrodechlorination reactor, to obtain the first reactant stream and the second reactant stream.

7. The process of claim 6, further comprising:
removing HCl from the product stream, and
feeding at least some of the HCl to the hydrochlorination.

8. The process of claim 6, further comprising:
removing hydrogen from a hydrochlorination product mixture in a condenser after the hydrochlorination, and
removing silicon tetrachloride and trichlorosilane from a remaining hydrochlorination product mixture in a distillation plant.

9. The process of claim 8, further comprising:
conducting, to the hydrodechlorination reactor, hydrogen removed in the condenser, the silicon tetrachloride removed in the distillation plant, or both.

10. The process of claim 1,
wherein heating the hydrodechlorination reactor comprises heating with a heating chamber, and
the hydrodechlorination reactor is in the heating chamber.

11. The process of claim 10,
wherein the hydrodechlorination reactor comprises a reactor tube in the heating chamber.

12. The process of claim 11,
wherein the heating chamber is a combustion chamber configured to be heated with combustion gas and combustion air,
the process further comprises feeding a flue gas which flows out of the combustion chamber to a downstream recuperator to preheat the combustion air, and
optionally, raising steam with the flue gas flowing out of the recuperator.

13. The process of claim 1,
wherein the cooling and the conducting together comprise conducting the product stream and the first reactant stream, the second reactant stream, or both through the heat exchanger under pressure, and
the heat exchanger comprises a heat exchanger element, comprising a ceramic material.

14. The process of claim 13,
wherein the ceramic material is selected from the group consisting of Al₂O₃, AlN, Si₃N₄, SiCN, and SiC.

15. The process of claim 13,
wherein the conducting comprises conducting the first reactant stream and the second reactant stream as a combined stream through the heat exchanger.

16. The process claim 13,
wherein a pressure difference between any two streams in the heat exchanger is not more than 10 bar, measured at inlets and outlets of the product stream and the first reactant stream, the second reactant stream, or both.

17. The process of claim 13,
wherein a pressure of the product stream at an inlet of the heat exchanger is not more than 2 bar below a pressure of the product stream at an outlet of the hydrodechlorination reactor.

18. The process of claim 1,
wherein the heat exchanger is a shell and tube heat exchanger.

19. A plant, comprising:
a hydrodechlorination reactor in a heating chamber or a combustion chamber, optionally comprising a reactor tube in a combustion chamber;
a first line configured to conduct a first gas comprising silicon tetrachloride and a second line configured to conduct a second gas comprising hydrogen, each leading into the hydrodechlorination reactor or the reactor tube, optionally in a combined line configured to conduct the first and second gases;
a product gas line conducted out of the hydrodechlorination reactor, for the product gas line configured to conduct a trichlorosilane-containing and HCl-containing product gas;
a heat exchanger through which the product gas line and the first line, the second line, or both are conducted, enabling heat transfer from the product gas line into the first line, the second line, or both, the heat exchanger optionally comprising a heat exchanger element comprising a ceramic material;
optionally a plant component configured to remove silicon tetrachloride, trichlorosilane, hydrogen, HCl, or a combination thereof from a product stream;
optionally a line configured to conduct silicon tetrachloride removed into the first line;
optionally a line configured to feed removed trichlorosilane fed to an end product removal process;
optionally a line configured to conduct hydrogen removed into the second line; and
optionally a line configured to remove HCl and to feed the HCl to a silicon hydrochlorinating plant,
wherein the plant is suitable for reacting silicon tetrachloride with hydrogen to form trichlorosilane.

20. The plant of claim 19,
further comprising:
an upstream hydrochlorination plant, optionally configured to receive HCl from a line configured to conduct HCl from a product stream;
a condenser configured to remove hydrogen from the hydrochlorination plant, and into the second line, leaving a remaining product mixture;
a distillation plant configured to remove silicon tetrachloride and trichlorosilane from the remaining product mixture and to feed silicon tetrachloride into the first line;
optionally a recuperator suitable for preheating a combustion air suitable for heating a combustion chamber, the preheating with a flue gas flowing out of the combustion chamber; and
optionally a plant suitable for raising steam from the flue gas flowing out of the recuperator.
